(19) United States
(12) Patent Application Publication
(10) Pub. No.: US 2025/0335745 A1
(43) Pub. Date: Oct. 30, 2025

(54) NON-TRANSITORY COMPUTER-READABLE RECORDING MEDIUM, PREDICTION METHOD, TRAINING METHOD, AND INFORMATION PROCESSING APPARATUS

(71) Applicants: Fujitsu Limited, Kawasaki-shi (JP); RIKEN, Wako-shi (JP)

(72) Inventors: Hiroki WAIDA, Ichikawa (JP); Yuichiro WADA, Setagaya (JP); Takashi KATOH, Kawasaki (JP); Atsushi TOKUHISA, Wako (JP)

(73) Assignees: Fujitsu Limited, Kawasaki-shi (JP); RIKEN, Wako-shi (JP)

(21) Appl. No.: 19/068,010

(22) Filed: Mar. 3, 2025

(30) Foreign Application Priority Data
Apr. 24, 2024 (JP) 2024-070804

(51) Int. Cl. G06N 3/0455

(52) U.S. Cl. CPC G06N 3/0455

(57) ABSTRACT

A non-transitory computer-readable recording medium has stored therein a prediction program that causes a computer to execute a process including inputting input data of reference timing and information of a lapse of time to a trained self-encoder, predicting an output from the trained self-encoder as noiseless data corresponding to the input data of the reference timing wherein the trained self-encoder has been trained such that an output in a case where data of a reference timing included in training data and information of a lapse of time are input approaches data of a timing corresponding to information of the lapse of time.

### CROSS-REFERENCE TO RELATED APPLICATION

This application is based upon and claims the benefit of priority of the prior Japanese Patent Application No. 2024-070804, filed on Apr. 24, 2024, the entire contents of which are incorporated herein by reference.

### FIELD

The embodiments discussed herein are related to a prediction program and the like.

### BACKGROUND

In a case where target data is acquired (imaging, recording, etc.) for a certain period under a predetermined situation, clean data may be denatured over time, and the denatured data may further include noise. In the following description, data including a change with time and including noise is referred to as “time-dependent data with noise”.

As a technique for removing noise of time-dependent data with noise, there is a conventional technique using deep learning. For example, in the prior art, an image pair is designated from moving image data, and a training model is trained using the designated image pair. In such a conventional technique, time-dependent data with noise is input to a trained training model to estimate clean data.

J. Xu, E. Adalsteinsson, Deformed2Self: Self-supervised denoising for dynamic medical imaging, in: Medical Image Computing and Computer Assisted Intervention-MICCAI 2021, Springer International Publishing, Cham, 2021, pp. 25-35.

### SUMMARY

According to an aspect of an embodiment, a non-transitory computer-readable recording medium has stored therein a prediction program that causes a computer to execute a process including inputting input data of reference timing and information of a lapse of time to a trained self-encoder, predicting an output from the trained self-encoder as noiseless data corresponding to the input data of the reference timing wherein the trained self-encoder has been trained such that an output in a case where data of a reference timing included in training data and information of a lapse of time are input approaches data of a timing corresponding to information of the lapse of time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining training data;

FIG. 2 is a diagram for explaining processing of training a self-encoder according to a first embodiment;

FIG. 3 is a functional block diagram illustrating a configuration of an information processing apparatus according to the first embodiment;

FIG. 4 is a flowchart illustrating a processing procedure at the time of training according to the first embodiment;

FIG. 5 is a flowchart illustrating a processing procedure at the time of prediction according to the first embodiment;

FIG. 6 is a diagram for explaining processing of training a self-encoder according to a second embodiment;

FIG. 7 is a functional block diagram illustrating a configuration of an information processing apparatus according to the second embodiment;

FIG. 8 is a flowchart illustrating a processing procedure at the time of training according to the second embodiment;

FIG. 9 is a flowchart illustrating a processing procedure at the time of prediction according to the second embodiment;

FIG. 10 is a diagram for explaining processing of creating a plurality of tasks;

FIG. 11 is a diagram for explaining processing of training a self-encoder according to a third embodiment;

FIG. 12 is a functional block diagram illustrating a configuration of an information processing apparatus according to the third embodiment;

FIG. 13 is a flowchart illustrating a processing procedure at the time of training according to the third embodiment; and

FIG. 14 is a diagram illustrating an example of a hardware configuration of a computer that implements functions similar to those of the information processing apparatus of the present embodiment.

### DESCRIPTION OF EMBODIMENTS

In the above-described conventional technique, there is a problem that noise removal performance is poor. Also, in the conventional technique, a statistical guarantee related to noise removal performance is not made clear.

Preferred embodiments of the present invention will be explained with reference to accompanying drawings. Note that the present invention is not limited by the examples.

### (a) First Embodiment

The information processing apparatus according to the first embodiment will be referred to as an “information processing apparatus 100”. The information processing apparatus 100 trains a self-encoder and predicts clean data for time-dependent data with noise using the trained self-encoder. Hereinafter, the processing of training the self-encoder executed by the information processing apparatus 100 and the processing of predicting the clean data will be sequentially described.

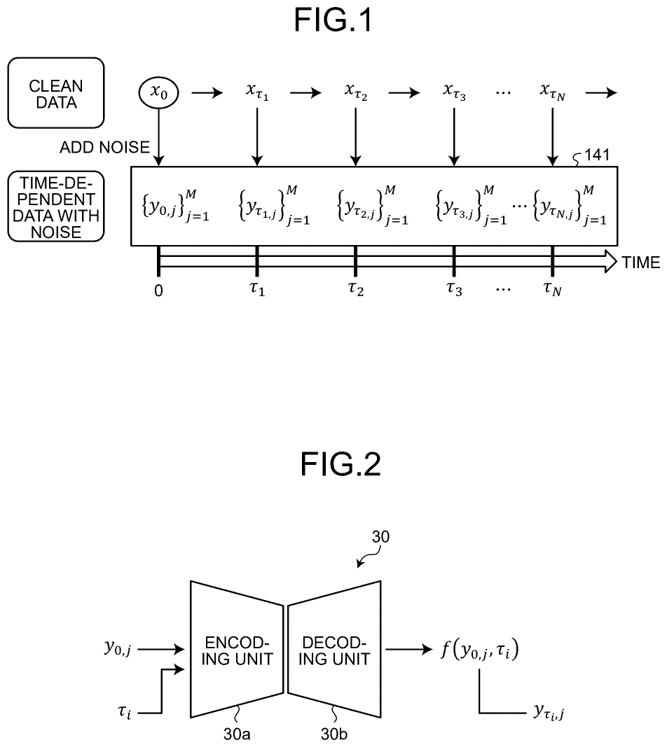

An example of processing in which the information processing apparatus 100 trains the self-encoder will be described. The information processing apparatus 100 trains the self-encoder using training data illustrated in FIG. 1. FIG. 1 is a diagram for explaining the training data.

As illustrated in FIG. 1, training data 141 includes time-dependent data with noise for each temporal change. For example, the time-dependent data with noise with the temporal change 0 is “y_{0,j}”. The time-dependent data with noise with the temporal change τ₁ is “y_{τ1,j}”. The time-dependent data with noise with the temporal change τ_{N} is “y_{τN,j}”. “j” set to each piece of time-dependent data with noise means a data series number. M is the maximum value of the data sequence number.

x₀ to x_{τN} illustrated in FIG. 1 are “theoretical clean data for each temporal change”. The clean data is denatured or damaged due to the temporal change. The clean data “x₀” with the temporal change 0 is clean data to be predicted by the information processing apparatus 100.

Data obtained by adding noise to the clean data “x₀” corresponds to the time-dependent data with noise “y_{0,j}”. Data obtained by adding noise to “x_{τ1}” corresponds to the time-dependent data with noise “y_{0,τ1}”. Data obtained by adding noise to “x_{τN}” corresponds to the time-dependent data with noise “y_{0,τN}”.

Note that assumptions regarding the time-dependent data with noise are indicated in Formulas (1), (2), and (3).

$$E [ {y}_{t} \vert {x}_{0} ] = {ϕ}_{t} ( {x}_{0} ) in any case t ∈ [ 0 , T ] \qquad ( 1 )$$

$$The {ϕ}_{t} is right - continuous at t = 0 and {x}_{0} ∈ {R}^{d} , \\ i . e . , {lim}_{t \to 0} {ϕ}_{t} ( {x}_{0} ) = {ϕ}_{0} ( {x}_{0} ) \qquad ( 2 )$$

$$In any case t , {t}^{′} ∈ [ 0 , T ] fulfilling t \neq {t}^{′} , \\ {y}_{t} and {y}_{{t}^{′}} are independent if they are conditioned on {x}_{0} \qquad ( 3 )$$

The information processing apparatus 100 does not generate the training data 141 by adding noise to the theoretical clean data for each temporal change, but directly acquires the training data 141 from an external device. For example, the external device is magnetic resonance imaging (MRI) or the like. The training data 141 is MRI image data or the like of each temporal change. In the first embodiment, the training data 141 is described as image data, but may be voice data or the like.

The information processing apparatus 100 trains the self-encoder using the training data 141 explained in FIG. 1. FIG. 2 is a diagram for explaining processing of training the self-encoder according to the first embodiment. For example, a self-encoder 30 includes an encoding unit 30a and a decoding unit 30b.

The information processing apparatus 100 inputs the time-dependent data with noise “y_{0,j}” and the information “τᵢ” on the temporal change to the self-encoder 30, thereby calculating the “f(y_{0,j},τᵢ)” output from the self-encoder 30. The information processing apparatus 100 updates parameters of the self-encoder 30 such that f(y_{0,j}, τᵢ) approaches y_{τi,j}. The information processing apparatus 100 trains the self-encoder 30 by repeatedly executing the above processing for j=1 to M and i=1 to N.

Note that the expected loss for the self-encoder 30 is expressed by Expression (4). By approximating Expression (4) using a Monte Carlo method, the empirical loss expressed in Expression (5) can be defined.

$$E [ {‖ f ( {y}_{0} , τ ) - {y}_{τ} ‖}_{2}^{2} \vert {x}_{0} ] \qquad ( 4 )$$

$$\frac{1}{MN} {\sum }_{j = 1}^{M} {\sum }_{i = 1}^{N} {‖ f ( {y}_{0 , j} , {τ}_{i} ) - {y}_{{τ}_{i , j}} ‖}_{2}^{2} \qquad ( 5 )$$

If the information processing apparatus 100 trains the self-encoder 30, that means updating the parameters of the self-encoder 30 so that the value of Expression (5) is minimized.

An example of the processing of training the self-encoder 30 executed by the information processing apparatus 100 has been described above. As described above, the information processing apparatus 100 updates the parameter of the self-encoder 30 such that the output f(y_{0,j}, τᵢ) in a case where the time-dependent data with noise “y_{0,j}” with the temporal change τ=0 included in the training data 141 and the temporal change τᵢ are input approaches y_{τi,j}. As a result, the self-encoder 30 capable of predicting the clean data x₀ at the temporal change τ=0 can be generated.

Next, an example of processing of predicting clean data executed by the information processing apparatus 100 will be described. The clean data to be predicted is “x₀” described in FIG. 1. The information processing apparatus 100 calculates f(y_{0,j}, 0) by inputting the time-dependent data with noise “y_{0,j}” and a temporal change “0 (τ=0)” to the trained self-encoder 30. The information processing apparatus 100 repeats the above processing for j=1 to M and predicts an average value of M f(y_{0,j}, 0) as the clean data x₀.

For example, the information processing apparatus 100 predicts clean data based on Expression (6).

$$\frac{1}{M} {\sum }_{j = 1}^{M} f ( {y}_{0 , j} , 0 ) \qquad ( 6 )$$

An example of processing of predicting clean data executed by the information processing apparatus 100 has been described above. As described above, the information processing apparatus 100 calculates f(y_{0,j}, 0) by inputting the time-dependent data with noise “y_{0,j}” and the temporal change “0 (τ=0)” to the trained self-encoder 30. Accordingly, the clean data x₀ can be predicted.

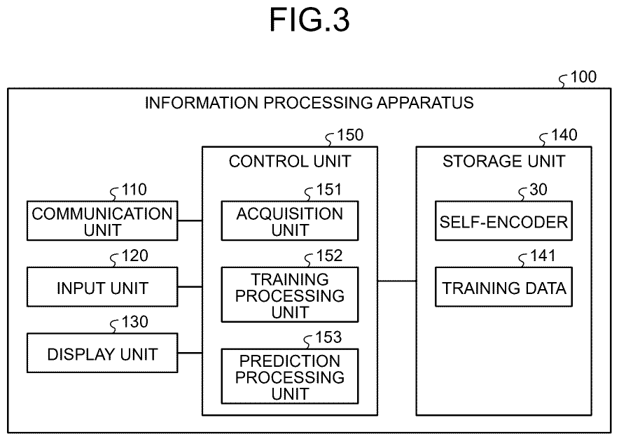

Next, a configuration example of the information processing apparatus 100 will be described. FIG. 3 is a functional block diagram illustrating the configuration of the information processing apparatus according to the first embodiment. As illustrated in FIG. 3, the information processing apparatus 100 includes a communication unit 110, an input unit 120, a display unit 130, a storage unit 140, and a control unit 150.

The communication unit 110 executes data communication with an external device or the like via a network. The communication unit 110 is a network interface card (NIC) or the like. For example, the communication unit 110 may acquire the training data 141 and the like from an external device or the like.

The input unit 120 is an input device that inputs various types of information to the control unit 150 of the information processing apparatus 100. For example, the input unit 120 corresponds to a keyboard, a mouse, a touch panel, or the like.

The display unit 130 is a display device that displays information output from the control unit 150.

The storage unit 140 includes a self-encoder 30 and training data 141. The storage unit 140 is a memory or the like.

The self-encoder 30 is the self-encoder 30 described in FIG. 2. The self-encoder 30 is a neural network (NN) or the like.

The training data 141 is the training data 141 described in FIG. 1. As described with reference to FIG. 1, the training data 141 includes time-dependent data with noise with respect to each temporal change.

Next, description of the control unit 150 will be made. The control unit 150 includes an acquisition unit 151, a training processing unit 152, and a prediction processing unit 153. The control unit 150 is a central processing unit (CPU), a graphics processing unit (GPU), or the like.

The acquisition unit 151 acquires the training data 141 from an external device or the like. The acquisition unit 151 stores the training data 141 in the storage unit 140. Note that the training data 141 may be stored in the storage unit 140 in advance.

The training processing unit 152 trains the self-encoder 30 using the training data 141. For example, the training processing unit 152 updates the parameter of the self-encoder 30 such that the output f(y_{0,j}, τᵢ) in a case where the time-dependent data with noise “y_{0,j}” with the temporal change τ=0 included in the training data 141 and the temporal change τᵢ are input approaches y_{τi,j}. For example, the training processing unit 152 uses back propagation when training the self-encoder 30.

Other descriptions executed by the training processing unit 152 are similar to those of the processing of training the self-encoder 30 described in FIG. 2.

The prediction processing unit 153 predicts the clean data x₀ using the trained self-encoder 30. For example, the prediction processing unit 153 calculates f(y_{0,j}, 0)<corresponding to the clean data> by inputting the time-dependent data with noise “y_{0,j}” and the temporal change “0 (τ=0)”. The prediction processing unit 153 may output and display the predicted clean data on the display unit 130, or may transmit the predicted clean data to an external device designated in advance.

Other processing executed by the prediction processing unit 153 are similar to the above-described processing of predicting clean data.

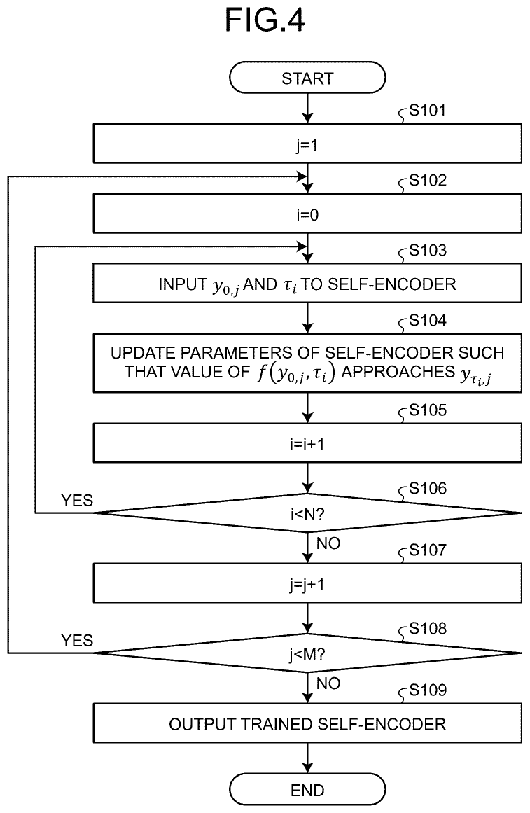

Next, an example of a processing procedure of the information processing apparatus 100 according to the first embodiment will be described. FIG. 4 is a flowchart illustrating a processing procedure at the time of training according to the first embodiment. As illustrated in FIG. 4, the training processing unit 152 of the information processing apparatus 100 sets j=1 (Step S101). The training processing unit 152 sets i=0 (Step S102).

The training processing unit 152 inputs the time-dependent data with noise y_{0,j} and the temporal change τᵢ to the self-encoder 30 (Step S103). The training processing unit 152 updates the parameters of the self-encoder 30 such that f(y_{0,j}, τᵢ) output from the self-encoder 30 approaches y_{τi, j} (Step S104).

The training processing unit 152 updates i by i=i+1 (Step S105). In a case where the condition of i<N is satisfied (Step S106, Yes), the training processing unit 152 proceeds to Step S103. On the other hand, in a case where the condition of i<N is not satisfied (Step S106, No), the training processing unit 152 proceeds to Step S107.

The training processing unit 152 updates j by j=j+1 (Step S107). In a case where the condition of j<M is satisfied (Step S108, Yes), the training processing unit 152 proceeds to Step S102. On the other hand, in a case where the condition of j<M is not satisfied (Step S108, No), the training processing unit 152 outputs the trained self-encoder 30 (Step S109).

Note that, in the processing illustrated in FIG. 4, the parameter of the self-encoder 30 is updated such that f(y_{0,j}, 0) approaches y_{τi,j} for one pair of “y_{0,j}” and τᵢ, but the present invention is not limited thereto. For example, the training processing unit 152 may update the parameters of the self-encoder 30 by applying the mini-batch training method. That is, the training processing unit 152 may update the parameters of the self-encoder 30 such that m f(y_{0,j}, 0) and y_{τi,j} approach m pairs of “y_{0,j}” and Ti, respectively.

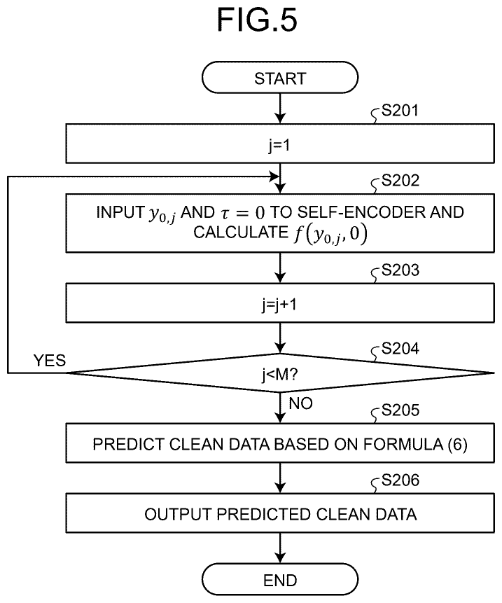

FIG. 5 is a flowchart illustrating a processing procedure at the time of prediction according to the first embodiment. Note that the self-encoder 30 described in FIG. 5 is a trained self-encoder 30. As illustrated in FIG. 5, the prediction processing unit 153 of the information processing apparatus 100 sets j=1 (Step S201).

The prediction processing unit 153 calculates f(y_{0,j}, 0) by inputting the time-dependent data with noise “y_{0,j}” and the temporal change “0 (τ=0)” to the self-encoder 30 (Step S202).

The prediction processing unit 153 updates j by j=j+1 (Step S203). In a case where the condition of j<M is satisfied (Step S204, Yes), the prediction processing unit 153 proceeds to Step S202. On the other hand, in a case where the condition of j<M is not satisfied (Step S204, No), the prediction processing unit 153 proceeds to Step S205.

The prediction processing unit 153 predicts the clean data based on Formula (6) (Step S205). The prediction processing unit 153 outputs the predicted clean data (Step S206).

Next, effects of the information processing apparatus 100 according to the first embodiment will be described. The information processing apparatus 100 updates the parameter of the self-encoder 30 such that the output f(y_{0,j}, τᵢ) in a case where the time-dependent data with noise “y_{0,j}” with the temporal change t=0 included in the training data 141 and the temporal change τᵢ are input approaches y_{τi,j}. As a result, the self-encoder 30 capable of predicting the clean data x₀ at the temporal change τ=0 can be generated.

In addition, the information processing apparatus 100 calculates f(y_{0,j}, 0) by inputting the time-dependent data with noise “y_{0,j}” and a temporal change “0 (τ=0)” to the trained self-encoder 30. Accordingly, the clean data x₀ can be predicted.

By the way, in the method of the information processing apparatus 100 described above, there is an improvement that it is difficult to generalize time-dependent noise data in a case where a degree of denaturation accompanying a temporal change is strong. Thus, for example, the self-encoder 30 may be trained in the following procedure.

Noise ϵ satisfying the condition expressed in Formula (7) is defined. In addition, an operation of adding the noise ϵ to the time-dependent data with noise “y₀” is defined by Formula (8). Similarly, the operation of adding the noise ϵ′ to the time-dependent data with noise “y_{τ}” (where τ≠0) is defined as m′.

$$E [ ε \vert {x}_{0} ] = 0 \qquad ( 7 )$$

$$m ( {y}_{0} ) = {y}_{0} + ε \qquad ( 8 )$$

Here, a main objective function L_{D} (f) for training the self-encoder 30 (self-encoder f) is defined by Expression (9).

$$E [ {‖ f ( m ( {y}_{0} ) , τ ) - {m}^{′} ( {y}_{τ} ) ‖}_{2}^{2} \vert {x}_{0} ] \qquad ( 9 )$$

Subsequently, a normalized L_{A} (f) that approximates the average of the prediction data and the average of the observation data is defined by Formula (10).

$${L}_{A} ( f ) = E [ \frac{1}{M} {\sum }_{j = 1}^{M} {‖ \frac{1}{N} {\sum }_{i = 1}^{N} f ( m ( {y}_{0 , j} ) , {τ}_{i} ) - \frac{1}{N} {\sum }_{i = 1}^{N} {m}^{′} ( {y}_{{τ}_{i , j}} ) ‖}_{2}^{2} ] \qquad ( 10 )$$

Subsequently, an empirical loss L_{D} (f) (hat) obtained by approximating the main objective function L_{D} (f) expressed in Expression (9) by a Monte Carlo method is defined by Formula (11). In addition, an empirical loss L_{A} (f) (hat) obtained by approximating the normalized L_{A} (f) expressed in Formula (10) by a Monte Carlo method is defined by Formula (12).

$${\hat{L}}_{D} ( f ) = \frac{1}{LMN} {\sum }_{k = 1}^{L} {\sum }_{j = 1}^{M} {{\sum }_{i = 1}}^{N} {‖ f ( {m}_{k} ( {y}_{0 , j} ) , {τ}_{i} ) - {m}_{k}^{′} ( {y}_{{τ}_{i , j}} ) ‖}_{2}^{2} \qquad ( 11 )$$

$${\hat{L}}_{A} ( f ) = \frac{1}{LM} {\sum }_{k = 1}^{L} {\sum }_{j = 1}^{M} {‖ \frac{1}{N} {\sum }_{i = 1}^{N} f ( {m}_{k} ( {y}_{0 , j} ) , {τ}_{i} ) - \frac{1}{N} {\sum }_{i = 1}^{N} {m}^{′} ( {y}_{{τ}_{i , j}} ) ‖}_{2}^{2} \qquad ( 12 )$$

The information processing apparatus 100 defines an objective function L_{T} obtained by adding an empirical loss L_{D} (f) (hat) and an empirical loss L_{A} (f) (hat). Note that a weight corresponding to M or N may be added to the empirical loss L_{A} (f) (hat) included in the objective function L_{T}.

The information processing apparatus 100 trains the self-encoder 30 so that the value of the objective function L_{T} is minimized. For example, the empirical loss L_{A} (f) (hat) in Formula (12) means that the self-encoder 30 is trained such that the average value when mₖ (y_{0,j}) and τᵢ are input to the self-encoder 30 approaches the average value of the training data 141 to which noise is added.

The processing of predicting the clean data by the information processing apparatus 100 using the trained self-encoder 30 is similar to the above processing.

### (b) Second Embodiment

Next, an information processing apparatus according to the second embodiment will be described. The information processing apparatus according to the second embodiment will be referred to as an “information processing apparatus 200”. In the method of the information processing apparatus 100 of the first embodiment described above, there is an issue that the time required for training becomes long in a case where there are a large amount of time-dependent data with noise of the training data 141. For example, the large number of time-dependent data with noise means that N is a predetermined number or more.

For example, the information processing apparatus 200 classifies the training data 141 into a plurality of clusters so as to maximize the mutual information amount. The information processing apparatus 200 prepares the number of decoding units included in the self-encoder by the number of cluster labels, and creates a decoding unit specialized for each cluster.

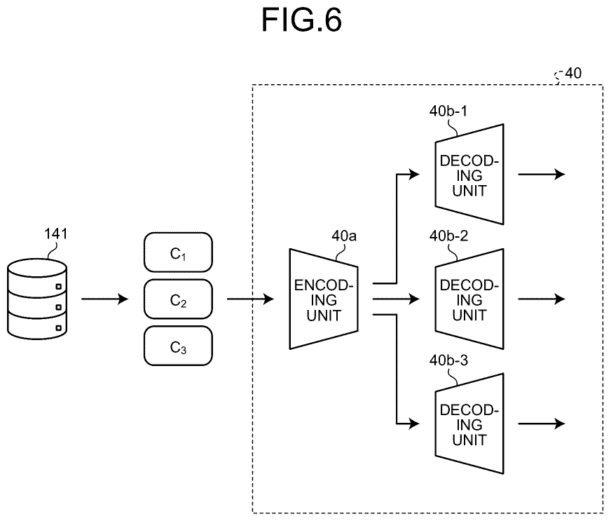

An example of processing in which the information processing apparatus 200 trains a self-encoder will be described. FIG. 6 is a diagram for explaining processing of training a self-encoder according to the second embodiment. For example, the information processing apparatus 200 classifies the training data 141 into clusters C₁, C₂, and C₃ by performing clustering on the training data 141. Furthermore, the information processing apparatus 200 prepares a self-encoder 40. The self-encoder 40 includes an encoding unit 40a and decoding units 40b-1, 40b-2, and 40b-3.

In FIG. 6, a case where the training data 141 is classified into clusters C₁, C₂, and C₃ will be described as an example, but the training data 141 may be classified into other clusters.

In a case where the self-encoder 40 is trained using the training data of the cluster C₁, the information processing apparatus 200 executes parameter update for a pair of the encoding unit 40a and the decoding unit 40b-1.

For example, the information processing apparatus 200 inputs the time-dependent data with noise “y_{0,j}” and the information “τᵢ” on the temporal change, which belong to the cluster C₁ to the self-encoder 40, thereby calculating the “f(y_{0,j}, τᵢ)” output from the self-encoder 40 (decoding unit 40b-1). The information processing apparatus 200 updates the parameters of the self-encoder 40 (parameters of the encoding unit 40a and the decoding unit 40b-1) such that f(y_{0,j}, τᵢ) approaches yτ_{i,j}.

In a case where the self-encoder 40 is trained using the training data of the cluster C₂, the information processing apparatus 200 executes parameter update for a pair of the encoding unit 40a and the decoding unit 40b-2.

For example, the information processing apparatus 200 inputs the time-dependent data with noise “y_{0,j}” and the information “τᵢ” on the temporal change, which belong to the cluster C₂ to the self-encoder 40, thereby calculating the “f(y_{0,j}, τᵢ)” output from the self-encoder 40 (decoding unit 40b-2). The information processing apparatus 200 updates the parameters of the self-encoder 40 (parameters of the encoding unit 40a and the decoding unit 40b-2) such that f(y_{0,j}, τᵢ) approaches y_{τi, j}.

In a case where the self-encoder 40 is trained using the training data of the cluster C₃, the information processing apparatus 200 executes parameter update for a pair of the encoding unit 40a and the decoding unit 40b-3.

For example, the information processing apparatus 200 inputs the time-dependent data with noise “y_{0,j}” and the information “τᵢ” on the temporal change, which belong to the cluster C₂ to the self-encoder 40, thereby calculating the “f(y_{0,j}, τᵢ)” output from the self-encoder 40 (decoding unit 40b-3). The information processing apparatus 200 updates the parameters of the self-encoder 40 (parameters of the encoding unit 40a and the decoding unit 40b-3) such that f(y_{0,j}, τᵢ) approaches y_{τi, j}.

An example of the processing of training the self-encoder 40 executed by the information processing apparatus 200 has been described above. Although the number of decoding units increases and the amount of calculation per epoch increases, since a decoding unit specialized for each cluster is created, the training can be completed in a time shorter than the time the information processing apparatus 100 according to the first embodiment requires for the training.

Next, an example of processing of predicting clean data executed by the information processing apparatus 200 will be described. The clean data to be predicted is “x₀” described in FIG. 1. The information processing apparatus 200 specifies a cluster to which the time-dependent data with noise “y_{0,j}” to be input belongs from the clusters C₁, C₂, and C₃.

In a case where the cluster to which the time-dependent data with noise “y_{0,j}” belongs is the cluster C₁, the information processing apparatus 200 inputs the time-dependent data with noise “y_{0,j}” and the temporal change “0 (τ=0)” to the encoding unit 40a of the self-encoder 40, and predicts the output of the decoding unit 40b-1 as clean data.

In a case where the cluster to which the time-dependent data with noise “y_{0,j}” belongs is the cluster C₂, the information processing apparatus 200 inputs the time-dependent data with noise “y_{0,j}” and the temporal change “0 (τ=0)” to the encoding unit 40a of the self-encoder 40, and predicts the output of the decoding unit 40b-2 as clean data.

In a case where the cluster to which the time-dependent data with noise “y_{0,j}” belongs is the cluster C₃, the information processing apparatus 200 inputs the time-dependent data with noise “y_{0,j}” and the temporal change “0 (τ=0)” to the encoding unit 40a of the self-encoder 40, and predicts the output of the decoding unit 40b-3 as clean data.

In a case where there is a plurality of pieces of time-dependent data with noise to be input, the information processing apparatus 200 may repeatedly execute the above processing on each piece of time-dependent data with noise and average the output results of the decoding units 40b-1 to 40b-3 to predict the clean data.

An example of processing of predicting clean data executed by the information processing apparatus 200 has been described above. As described above, even if there is a plurality of decoding units, the clean data can be appropriately predicted.

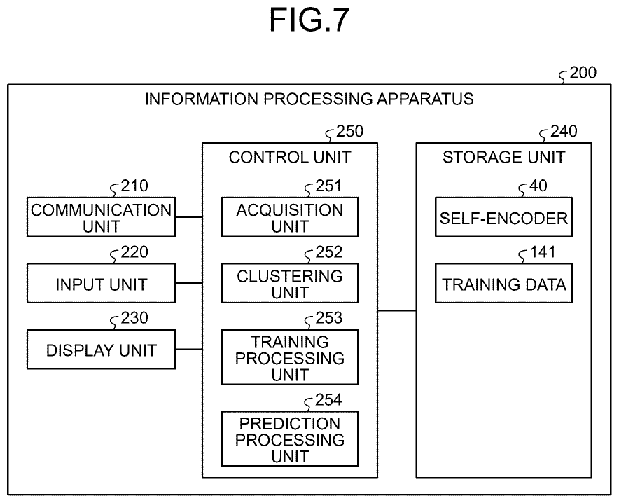

Next, a configuration example of the information processing apparatus 200 will be described. FIG. 7 is a functional block diagram illustrating a configuration of an information processing apparatus according to the second embodiment. As illustrated in FIG. 7, the information processing apparatus 200 includes a communication unit 210, an input unit 220, a display unit 230, a storage unit 240, and a control unit 250.

The description regarding the communication unit 210, the input unit 220, and the display unit 230 is similar to the description regarding the communication unit 110, the input unit 120, and the display unit 130 described in FIG. 3.

The storage unit 240 includes a self-encoder 40 and training data 141. The storage unit 240 is a memory or the like.

The self-encoder 40 is the self-encoder 40 described in FIG. 6. The self-encoder 40 is an NN or the like.

The training data 141 is the training data 141 described in FIG. 1. As described with reference to FIG. 1, the training data 141 includes time-dependent data with noise with respect to each temporal change.

Next, description of the control unit 250 will be made. The control unit 250 includes an acquisition unit 251, a clustering unit 252, a training processing unit 253, and a prediction processing unit 254. The control unit 250 is a CPU, a GPU, or the like.

The acquisition unit 251 acquires the training data 141 from an external device or the like. The acquisition unit 251 stores the training data 141 in the storage unit 240. Note that the training data 141 may be stored in the storage unit 240 in advance.

The clustering unit 252 classifies the training data 141 into a plurality of clusters so as to maximize the mutual information amount. The clustering unit 252 assigns a cluster label to each piece of time-dependent data with noise included in the training data 141 based on the classification result. The clustering unit 252 may execute clustering in advance, or may train a relationship between time-dependent data with noise and a cluster label during training and assign a cluster label to each piece of time-dependent data with noise based on a training result.

The training processing unit 253 trains the self-encoder 40 using the training data 141. For example, based on the cluster label of the time-dependent data with noise of the training data 141, the training processing unit 253 selects a decoding unit corresponding to the cluster label from the decoding units 40b-1 to 40b-3 and performs training.

Other descriptions executed by the training processing unit 253 are similar to those of the processing of training the self-encoder 40 described in FIG. 6.

The prediction processing unit 254 predicts the clean data x₀ using the trained self-encoder 40. For example, the prediction processing unit 254 selects a decoding unit corresponding to the cluster label of time-dependent data with noise and predicts clean data.

Other descriptions executed by the prediction processing unit 254 are similar to those of the above-described processing of predicting clean data.

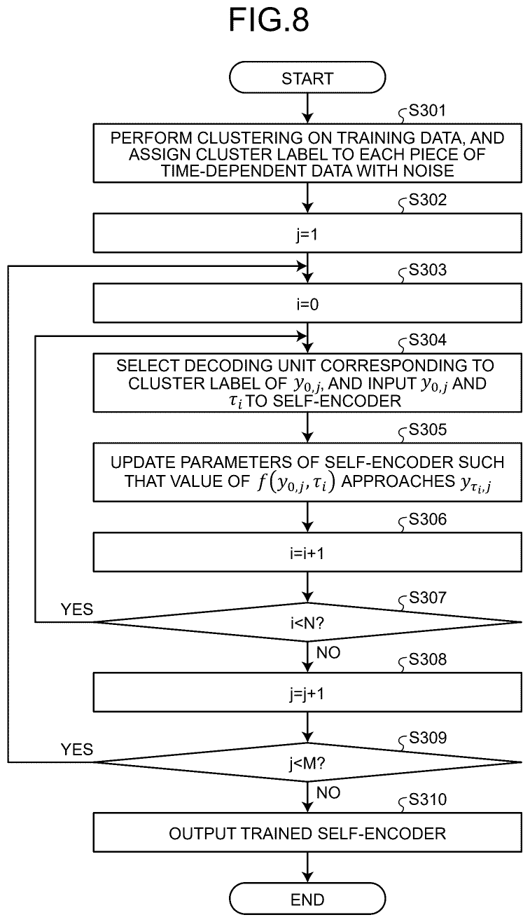

Next, an example of a processing procedure of the information processing apparatus 200 according to the second embodiment will be described. FIG. 8 is a flowchart illustrating a processing procedure at the time of training according to the second embodiment. As illustrated in FIG. 8, the clustering unit 252 of the information processing apparatus 200 performs clustering on the training data 141, and assigns a cluster label to each piece of time-dependent data with noise (Step S301).

The training processing unit 253 of the information processing apparatus 200 sets j=1 (Step S302). The training processing unit 253 sets i=0 (Step S303).

The training processing unit 253 selects a decoding unit corresponding to the cluster label of the time-dependent data with noise y_{0,j}, and inputs the time-dependent data with noise y_{0,j} and the temporal change τᵢ to the self-encoder 40 (Step S304). The training processing unit 253 updates the parameters of the self-encoder 40 such that f(y_{0,j}, τᵢ) output from the self-encoder 40 approaches y_{τi,j} (Step S305).

The training processing unit 253 updates i by i=i+1 (Step S306). In a case where the condition of i<N is satisfied (Step S307, Yes), the training processing unit 253 proceeds to Step S304. On the other hand, in a case where the condition of i<N is not satisfied (Step S307, No), the training processing unit 152 proceeds to Step S308.

The training processing unit 253 updates j by j=j+1 (Step S308). In a case where the condition of j<M is satisfied (Step S309, Yes), the training processing unit 253 proceeds to Step S303. On the other hand, in a case where the condition of j<M is not satisfied (Step S309, No), the training processing unit 253 outputs the trained self-encoder 40 (Step S310).

Note that, in the processing illustrated in FIG. 8, the parameter of the self-encoder 40 is updated such that f(y_{0,j}, 0) approaches y_{τi,j} for one pair of “y_{0,j}” and τᵢ, but the present invention is not limited thereto. For example, the training processing unit 253 may update the parameters of the self-encoder 40 by applying the mini-batch training method. That is, the training processing unit 253 may update the parameters of the self-encoder 30 such that m f(y_{0,j}, 0) and y_{τi,j} approach m pairs of “y_{0,j}” and τᵢ, respectively.

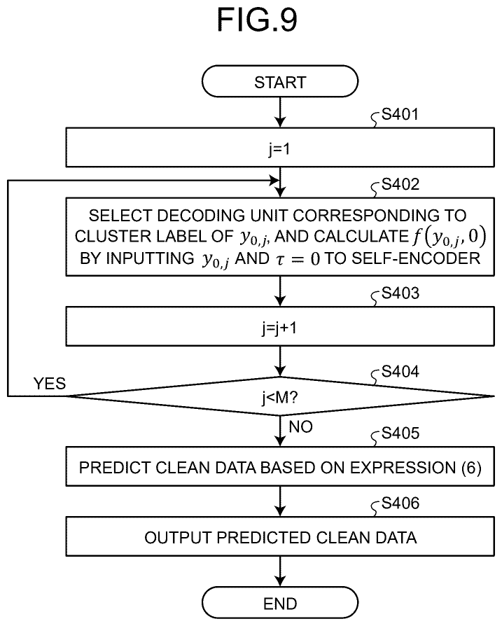

FIG. 9 is a flowchart illustrating a processing procedure at the time of prediction according to the second embodiment. Note that the self-encoder 40 described in FIG. 9 is a trained self-encoder 40. As illustrated in FIG. 9, the prediction processing unit 254 of the information processing apparatus 200 sets j=1 (Step S401).

The prediction processing unit 254 selects a decoding unit corresponding to the cluster label of the time-dependent data with noise y_{0,j}, and calculates f(y_{0,j}, 0) by inputting the time-dependent data with noise “y_{0,j}” and the temporal change “0 (τ=0)” to the self-encoder 40 (Step S402).

The prediction processing unit 254 updates j by j=j+1 (Step S403). In a case where the condition of j<M is satisfied (Step S404, Yes), the prediction processing unit 254 proceeds to Step S402. On the other hand, in a case where the condition of j<M is not satisfied (Step S404, No), the prediction processing unit 254 proceeds to Step S405.

The prediction processing unit 254 predicts the clean data based on Expression (6) (Step S405). The prediction processing unit 254 outputs the predicted clean data (Step S406).

Next, effects of the information processing apparatus 200 according to the second embodiment will be described. The information processing apparatus 200 classifies the training data 141 into a plurality of clusters, prepares the number of decoding units included in the self-encoder by the number of cluster labels, and creates a decoding unit specialized for each cluster. According to the information processing apparatus 200, although the number of decoding units increases and the amount of calculation per epoch increases, since a decoding unit specialized for each cluster is created, the training can be completed in a time shorter than the time the information processing apparatus 100 according to the first embodiment requires for the training.

### (c) Third Embodiment

Next, an information processing apparatus according to the third embodiment will be described. The information processing apparatus according to the third embodiment will be referred to as an “information processing apparatus 300”. The information processing apparatus 300 sets data handled as training data (and evaluation data) as “cryoEM micrograph data”. In the third embodiment, a set of the training data and the evaluation data is appropriately referred to as a “task”. The evaluation data is data used to evaluate a training result of a target (self-encoder), and is, for example, cryo-electron microscopy (cryoEM) micrograph data with a temporal change (time) 0 (τ=0).

For example, the cryoEM micrograph data is widely used for imaging biomolecules. Here, measurement is performed under severe conditions under low dose in order to avoid radiation damage of biomolecules as samples. For this reason, the signal-to-noise ratio of each acquired “cryoEM micrograph data” is poor, which may cause significant degradation in the estimation performance of parameters such as three-dimensional reconstruction in post-stage analysis.

For example, the information processing apparatus 300 uses an external device such as an electron microscope (low temperature electron microscope) to repeatedly measure a low dose in the same field of view of the same sample for a longer time than usual. The signal-to-noise ratio of the cumulative image of the time-series data obtained by such measurement becomes higher than usual, but becomes data (long-time exposure cryoEM micrograph data) influenced by radiation damage in the latter half of the measurement.

By applying the method of the first embodiment (D2N2 method) to the long-time exposure cryoEM micrograph data, clean data having less influence of radioactive damage is predicted. By the long-time exposure cryoEM micrograph data and the D2N2 method, it is possible to substantially obtain high-performance cryoEM micrograph data having less influence of radioactive damage and a high signal-to-noise ratio, which are usually difficult to obtain. By using this high-performance cryoEM micrograph data, the parameter estimation accuracy of the post-stage analysis can be significantly improved, and the performance of biomolecule imaging can be improved.

Here, when cryoEM micrograph data is directly applied to the method of the first embodiment (D2N2 method), the following problem occurs. Since the particles of the cryoEM micrograph data deteriorate rapidly with a lapse of time, it is difficult to sufficiently secure the sequence length of the time-series data in which the lapse of time of the same particle is recorded. This corresponds to the fact that N of the training data of the first embodiment is small. For example, if the task (training data) is insufficient, a self-encoder having a sufficient noise removal function may not be generated.

Regarding the above problems, in the third embodiment, attention is paid to the following points. For example, since the field of view of the camera that images the cryoEM micrograph data is wide, a plurality of particles can be simultaneously imaged under the same environment, and there are a plurality of other particles having a strong correlation between the temporal change and the noise process. In addition, it is assumed that there are M different tasks having a property similar to the noise removal task for the target particle.

The information processing apparatus 300 trains the self-encoder by transfer learning of M-Task-N-shot or meta-learning with respect to the M pieces of time-series data having the length N acquired under the similar environment based on the content of interest described above.

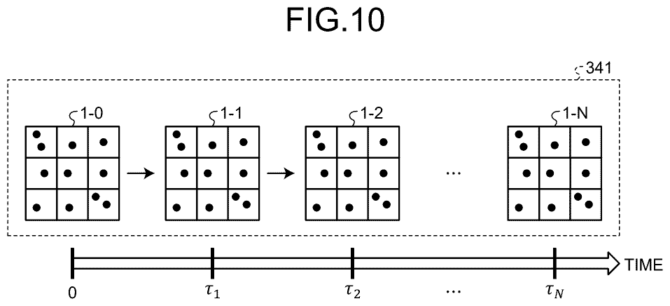

An example of processing in which the information processing apparatus 300 creates a plurality of tasks will be described. FIG. 10 is a diagram for explaining processing of creating a plurality of tasks. In the following description, the cryoEM micrograph data is abbreviated as “cryo data”. The information processing apparatus 300 acquires time-series cryo data (training data 341) from an external device such as an electron microscope.

In the example illustrated in FIG. 10, the time-series cryo data (training data 341) includes cryo data 1-0 of the temporal change 0, cryo data 1-1 of the temporal change τ₁, cryo data 1-2 of the temporal change τ₂, and cryo data 1-N of the temporal change τ_{N}. Black circles indicated in the cryo data 1-0 to 1-N indicate particles.

The information processing apparatus 300 divides the cryo data 1-0 to 1-N into a plurality of regions. FIG. 10 illustrates an example in which the cryo data 1-0 to 1-N is divided into 3 rows and 3 columns, but the present invention is not limited thereto, and the region may be divided for each particle. In the third embodiment, the images in the X-th row and the Y-th column of the divided regions of the cryo data are referred to as a partial image (X, Y).

The information processing apparatus 300 generates a partial image (1,1) of the cryo data 1-0, a partial image (1,1) of the cryo data 1-1, a partial image (1,1) of the cryo data 1-2, . . . , and a partial image (1, 1) of the cryo data 1-N as one task. The information processing apparatus 300 may set the partial image (1,1) of the cryo data 1-0 as the evaluation data of the task.

The information processing apparatus 300 generates a plurality of tasks by collecting partial images at the same position using other partial images of the cryo data 1-0 to 1-N. For example, the partial images (1,2) of the cryo data 1-0 to 1-N are collectively set as one task. The same applies to the partial images (1, 3) to (3,3) of the cryo data 1-0 to 1-N. As a result, nine tasks are created from the cryo data in time series (training data 341).

The information processing apparatus 300 creates a plurality of tasks by executing the processing described with reference to FIG. 10 even for cryo data of another time series (time) acquired from an external device. Note that information regarding the imaging environment is added to the time-series cryo data acquired from the external device. The information processing apparatus 300 performs processing of classifying tasks generated from the cryo data of the same imaging environment into the same group.

The information processing apparatus 300 trains the self-encoder using the plurality of tasks created by the processing described in FIG. 10. Hereinafter, an example of processing in which the information processing apparatus 300 trains a self-encoder will be described.

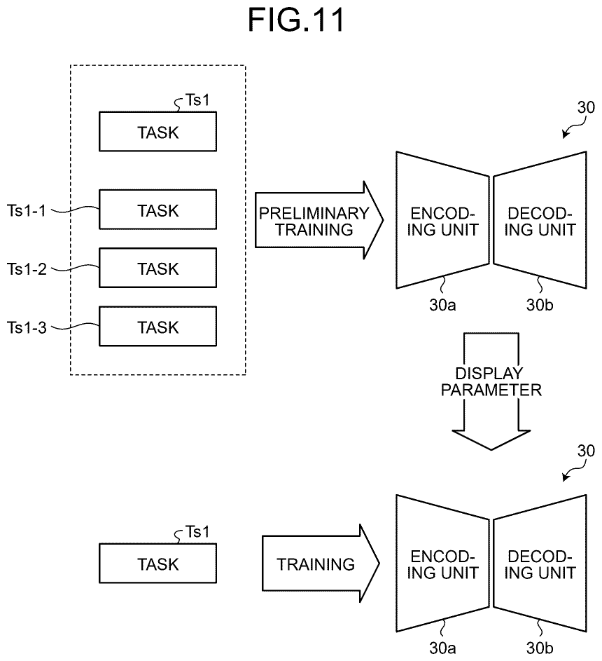

FIG. 11 is a diagram for explaining processing of training a self-encoder according to a third embodiment. For example, the information processing apparatus 100 described in the first embodiment sets a random initial parameter as an initial parameter of the self-encoder 30. On the other hand, the information processing apparatus 300 performs preliminary training by using a plurality of tasks classified into the same group, and uses a parameter obtained by the preliminary training as an initial parameter. Each of the plurality of tasks classified into the same group is a task created from cryo data imaged under the same environment.

In the example illustrated in FIG. 11, the other tasks belonging to the same group as the task Ts1 are assumed as tasks Ts1-1, Ts1-2, and Ts1-3. The information processing apparatus 300 provides the preliminary training to the self-encoder 30 using the tasks Ts1, Ts1-1 to Ts1-3.

When the preliminary training is completed, the information processing apparatus 300 uses the parameter of the self-encoder 30 at the end of the preliminary training as the initial parameter of the training using the task Ts1. The information processing apparatus 300 trains the self-encoder 30 using the task Ts1.

Note that the contents of the processing of the information processing apparatus 300 for preliminary training (training) the self-encoder 30 using the tasks Ts1, Ts1-1 to Ts1-3 are similar to the contents of the training described in the first embodiment.

Note that the processing described with reference to FIG. 11 is processing corresponding to transfer learning (for example, joint training). The information processing apparatus 300 may train the self-encoder 30 by meta learning described below.

For example, the information processing apparatus 300 may classify a plurality of tasks classified into the same group into evaluation data (partial image of τ=0) and other training data, and perform training using a common initial parameter that minimizes a loss of each evaluation data due to a trained parameter for each task trained by a loss of each training data. In a case where such an initial parameter is calculated, the information processing apparatus 300 uses an algorithm such as model-agnostic meta-learning (MAML) (Finn et al, 2017).

An example of the processing of training the self-encoder 30 executed by the information processing apparatus 300 has been described above. As described above, the information processing apparatus 300 performs preliminary training by using a plurality of tasks created from cryo data imaged under the same environment, and performs training of the self-encoder 30 by using a parameter obtained as a result of the preliminary training as an initial parameter. As a result, even in a case where it is difficult to sufficiently secure the sequence length of the time-series data in which the lapse of time of the same particle is recorded, it is possible to create the self-encoder 30 capable of predicting clean data with high accuracy.

Next, an example of processing of predicting clean data (target molecule) executed by the information processing apparatus 300 will be described. The information processing apparatus 300 sets a partial image including a target particle and having a temporal change of 0 as “y_{0,j}”. The information processing apparatus 300 calculates f(y_{0,j}, 0) by inputting the “y_{0,j}” and the temporal change “0 (τ=0)” to the trained self-encoder 30. The information processing apparatus 300 repeats the above processing for j=1 to M and predicts an average value of M f(y_{0,j}, 0) as the clean data x₀.

An example of processing of predicting clean data executed by the information processing apparatus 300 has been described above.

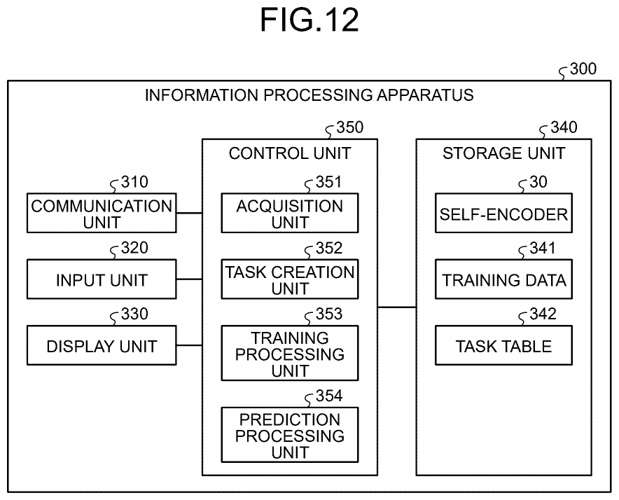

Next, a configuration example of the information processing apparatus 300 will be described. FIG. 12 is a functional block diagram illustrating a configuration of an information processing apparatus according to the third embodiment. As illustrated in FIG. 12, the information processing apparatus 300 includes a communication unit 310, an input unit 320, a display unit 330, a storage unit 340, and a control unit 350.

The communication unit 310 executes data communication with an external device (electron microscope) or the like via a network. The communication unit 310 is an NIC or the like. For example, the communication unit 310 may acquire the training data 341 and the like from an external device or the like.

The input unit 320 is an input device that inputs various types of information to the control unit 350 of the information processing apparatus 300. For example, the input unit 320 corresponds to a keyboard, a mouse, a touch panel, or the like.

The display unit 330 is a display device that displays information output from the control unit 350.

The storage unit 340 includes a self-encoder 30, training data 341, and a task table 342. The storage unit 340 is a memory or the like.

The self-encoder 30 is the self-encoder 30 described in FIG. 2. The self-encoder 30 is an NN or the like.

The training data 341 is the training data 341 described in FIG. 10. The training data 341 is time-series cryo data. Note that the storage unit 340 may have a plurality of pieces of training data imaged under the same environment. Each training data is given information on the imaging environment when the time-series cryo data is imaged.

The task table 342 is a table that holds a plurality of tasks created from the training data 341 described in FIG. 10. For example, in the task table 342, tasks created from cryo data imaged under the same environment are classified into the same group.

Next, description of the control unit 350 will be made. The control unit 350 includes an acquisition unit 351, a task creation unit 352, a training processing unit 353, and a prediction processing unit 354. The control unit 350 is a CPU, a GPU, or the like.

The acquisition unit 351 acquires the training data 341 from an external device or the like. The acquisition unit 351 stores the training data 341 in the storage unit 340. Note that the training data 341 may be stored in the storage unit 340 in advance.

The task creation unit 352 creates a plurality of tasks based on the training data 341. The description of the processing of creating a plurality of tasks by the task creation unit 352 is similar to the description of the processing described in FIG. 10.

The task creation unit 352 stores the created tasks in the task table 342. The task creation unit 352 stores the tasks in the task table 342 while classifying the tasks created from the cryo data imaged under the same environment into the same group.

The training processing unit 353 performs preliminary training of the self-encoder 30 using a plurality of tasks classified into the same group stored in the task table 342, and uses a parameter obtained by the preliminary training as an initial value of the self-encoder 30. After the preliminary training, the training processing unit 353 trains the self-encoder 30 using a task of an image (partial image) including a target particle.

Other descriptions executed by the training processing unit 353 are similar to those of the processing of training the self-encoder 30 described in FIG. 11.

The prediction processing unit 354 calculates f(y_{0,j}, 0) by inputting the partial image “y_{0,j}” including the target particle and having the temporal change of 0 and the temporal change “0 (τ=0)” to the trained self-encoder 30. The prediction processing unit 354 repeats the above processing for j=1 to M and predicts an average value of M f(y_{0,j}, 0) as the clean data x₀.

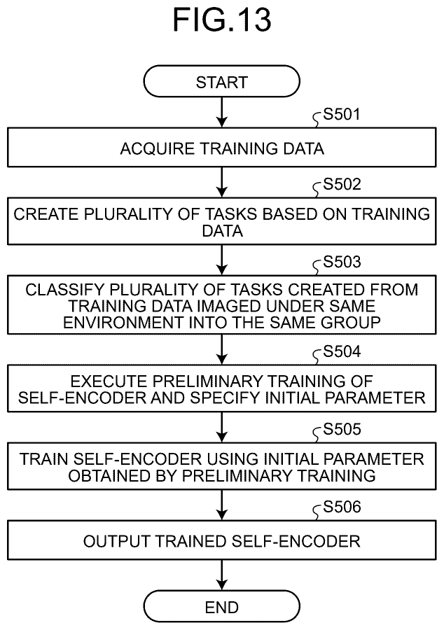

Next, an example of a processing procedure of the information processing apparatus 300 according to the third embodiment will be described. FIG. 13 is a flowchart illustrating a processing procedure at the time of training according to the third embodiment. As illustrated in FIG. 13, the task creation unit 352 of the information processing apparatus 300 acquires the training data 341 (Step S501).

The task creation unit 352 creates a plurality of tasks based on the training data 341 (Step S502). The task creation unit 352 classifies the plurality of tasks created from the training data 341 imaged under the same environment into the same group (Step S503).

The training processing unit 353 executes preliminary training of the self-encoder 30 using the plurality of tasks classified into the same group and specifies an initial parameter (Step S504).

The training processing unit 353 trains the self-encoder 30 using the initial parameter obtained by the preliminary training (Step S505). The training processing unit 353 outputs the trained self-encoder 30 (Step S506).

Note that the description of the processing procedure at the time of prediction according to the third embodiment is similar to the processing procedure described in FIG. 5 of the first embodiment except that the target image is different, and thus illustration is omitted.

Next, effects of the information processing apparatus 300 according to the third embodiment will be described. The information processing apparatus 300 performs preliminary training by using a plurality of tasks created from cryo data imaged under the same environment, and performs training of the self-encoder 30 by using a parameter obtained as a result of the preliminary training as an initial parameter. As a result, even in a case where it is difficult to sufficiently secure the sequence length of the time-series data in which the lapse of time of the same particle is recorded, it is possible to create the self-encoder 30 capable of predicting clean data with high accuracy.

Note that, in a case where the preliminary training of the self-encoder 30 is performed on the target particle, the information processing apparatus 300 may calculate similarity between the task of the target particle and another task, preferentially select a task having high similarity, and perform the preliminary training of the self-encoder 30.

Furthermore, a case where the information processing apparatus 300 creates a plurality of tasks has been described with reference to FIG. 10, but the present invention is not limited thereto. For example, the information processing apparatus 300 may prepare a plurality of series of cryo entire images (training data 341) and use each of the plurality of series of training data as a task.

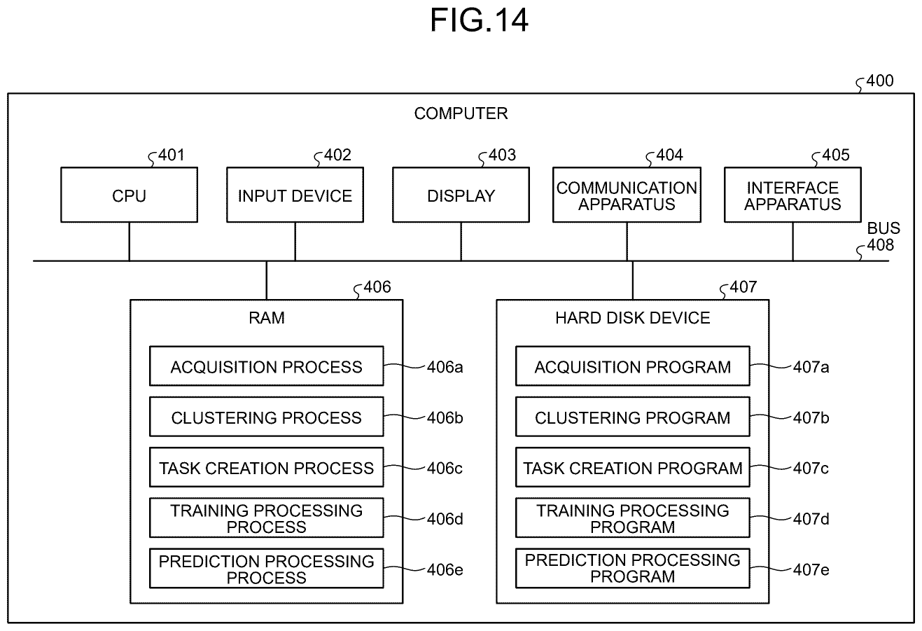

Next, an example of a hardware configuration of a computer that implements functions similar to those of the information processing apparatus 100 (200, 300) described above will be described. FIG. 14 is a diagram illustrating an example of a hardware configuration of a computer that implements functions similar to those of the information processing apparatus of the present embodiment.

As illustrated in FIG. 14, a computer 400 includes a CPU 401 that executes various types of arithmetic processing, an input device 402 that receives an input of data from a user, and a display 403. Furthermore, the computer 400 includes a communication apparatus 404 that exchanges data with an external device or the like via a wired or wireless network, and an interface apparatus 405. In addition, the computer 400 includes a RAM 406 that temporarily stores various types of information and a hard disk device 407. Furthermore, each device 401 to 407 is connected to a bus 408.

The hard disk device 407 includes an acquisition program 407a, a clustering program 407b, a task creation program 407c, a training processing program 407d, and a prediction processing program 407e. The CPU 401 reads the programs 407a to 407e and develops the programs in the RAM 406.

The acquisition program 407a functions as an acquisition process 406a. The clustering program 407b functions as a clustering process 406b. The task creation program 407c functions as a task creation process 406c. The training processing program 407d functions as a training processing process 406d. The prediction processing program 407e functions as a prediction processing process 406e.

The processing of the acquisition process 406a corresponds to the processing of the acquisition units 151, 251, and 351 The processing of the clustering process 406b corresponds to the processing of the clustering unit 252. The processing of the task creation process 406c corresponds to the processing of the task creation unit 352 The processing of the training processing process 406d corresponds to the processing of the training processing units 152, 253, and 353. The processing of the prediction processing process 406e corresponds to the processing of the prediction processing units 153, 254, and 354.

Note that the programs 407a to 407d do not necessarily need to be stored in the hard disk device 407 from the beginning. For example, each program is stored in a “portable physical medium” such as a flexible disk (FD), a CD-ROM, a DVD, a magneto-optical disk, or an IC card inserted into the computer 400. Then, the computer 400 may read and execute the programs 407a to 407e.

It is possible to improve noise removal performance.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a prediction program that causes a computer to execute a process comprising:
inputting input data of reference timing and information of a lapse of time to a trained self-encoder; and
predicting an output from the trained self-encoder as noiseless data corresponding to the input data of the reference timing,
wherein the trained self-encoder has been trained such that an output in a case where data of a reference timing included in training data and information of a lapse of time are input approaches data of a timing corresponding to information of the lapse of time.

2. The non-transitory computer-readable recording medium according to claim 1, wherein the process further includes inputting a set of the data of the reference timing and information indicating a reference timing as information of a lapse of time to the self-encoder for each index, and predicting an average value of outputs of the self-encoder as the noiseless data.

3. A non-transitory computer-readable recording medium having stored therein a training program that causes a computer to execute a process comprising:
acquiring, as training data, a plurality of pieces of data including a change with a lapse of time and including noise; and
training a self-encoder such that an output in a case where data of a reference timing included in the training data and information of a lapse of time are input approaches data of a timing corresponding to the information of the lapse of time.

4. The non-transitory computer-readable recording medium according to claim 3, wherein the process further includes adding noise to a plurality of pieces of data included in the training data, calculating a first average value of the plurality of pieces of data obtained by further adding noise, and training the self-encoder such that a second average value of an output in a case where a plurality of sets of the data to which the noise at the reference timing is added and information of a lapse of time is input to the self-encoder approaches the first average value.

5. The non-transitory computer-readable recording medium according to claim 3, wherein the self-encoder includes a plurality of decoders, and the process further includes classifying the training data into a plurality of groups, and training the self-encoder such that an output from a decoder corresponding to a certain group among the plurality of decoders in a case where data of the reference timing belonging to the certain group and information of a lapse of time are input approaches data of a timing corresponding to the information of the lapse of time.

6. The non-transitory computer-readable recording medium according to claim 3, wherein the process further includes creating a plurality of tasks based on the training data, specifying an initial parameter of the self-encoder by performing preliminary training of the self-encoder using, among the plurality of tasks, a first task and a plurality of tasks similar to the first task, and training the self-encoder using the initial parameter and the first task.

7. A prediction method comprising:
inputting input data of reference timing and information of a lapse of time to a trained self-encoder; and
predicting an output from the trained self-encoder as noiseless data corresponding to the input data of the reference timing, by a processor,
wherein the trained self-encoder has been trained such that an output in a case where data of a reference timing included in training data and information of a lapse of time are input approaches data of a timing corresponding to information of the lapse of time.

8. The method of prediction according to claim 7, further including inputting a set of the data of the reference timing and information indicating a reference timing as information of a lapse of time to the self-encoder for each index, and predicting an average value of outputs of the self-encoder as the noiseless data.

9. A training method comprising:
acquiring, as training data, a plurality of pieces of data including a change with a lapse of time and including noise; and
training a self-encoder such that an output in a case where data of a reference timing included in the training data and information of a lapse of time are input approaches data of a timing corresponding to the information of the lapse of time, by a processor.

10. The method of training according to claim 9, further including adding noise to a plurality of pieces of data included in the training data, calculating a first average value of the plurality of pieces of data obtained by further adding noise, and training the self-encoder such that a second average value of an output in a case where a plurality of sets of the data to which the noise at the reference timing is added and information of a lapse of time is input to the self-encoder approaches the first average value.

11. The training method according to claim 9, wherein the self-encoder includes a plurality of decoders, and the training method further includes classifying the training data into a plurality of groups, and training the self-encoder such that an output from a decoder corresponding to a certain group among the plurality of decoders in a case where data of the reference timing belonging to the certain group and information of a lapse of time are input approaches data of a timing corresponding to the information of the lapse of time.

12. The method of training according to claim 9, further including creating a plurality of tasks based on the training data, specifying an initial parameter of the self-encoder by performing preliminary training of the self-encoder using, among the plurality of tasks, a first task and a plurality of tasks similar to the first task, and training the self-encoder using the initial parameter and the first task.

13. An information processing apparatus comprising:
a memory; and
a processor coupled to the memory and configured to:
input data of reference timing and information of a lapse of time to a trained self-encoder; and
predict an output from the trained self-encoder as noiseless data corresponding to the input data of the reference timing,
wherein the trained self-encoder has been trained such that an output in a case where data of a reference timing included in training data and information of a lapse of time are input approaches data of a timing corresponding to information of the lapse of time.

14. The information processing apparatus according to claim 13, wherein the processor is further configured to input a set of the data of the reference timing and information indicating a reference timing as information of a lapse of time to the self-encoder for each index, and predict an average value of outputs of the self-encoder as the noiseless data.

15. An information processing apparatus comprising:
a memory; and
a processor coupled to the memory and configured to:
acquire, as training data, a plurality of pieces of data including a change with a lapse of time and including noise; and
train a self-encoder such that an output in a case where data of a reference timing included in the training data and information of a lapse of time are input approaches data of a timing corresponding to the information of the lapse of time.

16. The information processing apparatus according to claim 15, wherein the processor is further configured to add noise to a plurality of pieces of data included in the training data, calculate a first average value of the plurality of pieces of data obtained by further adding noise, and train the self-encoder such that a second average value of an output in a case where a plurality of sets of the data to which the noise at the reference timing is added and information of a lapse of time is input to the self-encoder approaches the first average value.

17. The information processing apparatus according to claim 15, wherein the self-encoder includes a plurality of decoders, and the processor is further configured to classify the training data into a plurality of groups, and train the self-encoder such that an output from a decoder corresponding to a certain group among the plurality of decoders in a case where data of the reference timing belonging to the certain group and information of a lapse of time are input approaches data of a timing corresponding to the information of the lapse of time.

18. The information processing apparatus according to claim 15, wherein the processor is further configured to create a plurality of tasks based on the training data, specify an initial parameter of the self-encoder by performing preliminary training of the self-encoder using, among the plurality of tasks, a first task and a plurality of tasks similar to the first task, and train the self-encoder using the initial parameter and the first task.
